(19) United States
(12) Patent Application Publication
(10) Pub. No.: US 2017/0296873 A1
(43) Pub. Date: Oct. 19, 2017

(54) EXERCISE INFORMATION MEASUREMENT APPARATUS, CONTROL METHOD FOR EXERCISE INFORMATION MEASUREMENT APPARATUS, CONTROL PROGRAM FOR EXERCISE INFORMATION MEASUREMENT APPARATUS

(71) Applicant: OMRON HEALTHCARE CO., LTD., Muko-shi (JP)

(72) Inventor: Yumi KITAMURA, Kyoto (JP)

(73) Assignee: OMRON HEALTHCARE CO., LTD., Muko-shi (JP)

(21) Appl. No.: 15/636,034

(22) Filed: Jun. 28, 2017

Related U.S. Application Data
(63) Continuation of application No. PCT/JP2016/050679, filed on Jan. 12, 2016.

(30) Foreign Application Priority Data
Jan. 22, 2015 (JP) 2015-010343

(51) Int. Cl. A63B 24/00; H04Q 9/00

(52) U.S. Cl. CPC A63B 24/0062; H04Q 9/00; H04Q 2209/43; A63B 2230/75; A63B 2220/17; A63B 2220/808; A63B 2220/40; A63B 2220/30; A63B 2220/20; H04Q 2209/883; A63B 2225/50

(57) ABSTRACT

An exercise information measurement apparatus, a control method therefor, and a control program therefor, according to which it is possible to suppress power consumption and provide a user with additional value obtained by using a near-field wireless communication function. An exercise information measurement apparatus includes: a body motion detection unit that detects information corresponding to a motion of a user; a communication unit for performing near-field wireless communication with another apparatus having a function of measuring exercise information of a user; a sound detection unit that detects sound; and a control unit that measures exercise information of the user based on the information detected by the body motion detection unit, determines the presence of a person based on the sound detected by the sound detection unit, and based on the determination result, controls an operation state of the communication unit.

### TECHNICAL FIELD

The present invention relates to an exercise information measurement apparatus, a control method for an exercise information measurement apparatus, and a control program for an exercise information measurement apparatus.

### BACKGROUND ART

In recent years, there have been many developments in exercise information measurement apparatuses that can measure exercise information such as an activity amount (step count, walking distance, expended calories, and the like) or a movement speed (walking speed, running speed, and the like) by using a motion detection sensor that detects a motion of a body, such as an acceleration sensor or an angular velocity sensor. There are known to be such exercise information measurement apparatuses that have a near-field wireless communication function, and various services can be provided by using this function.

For example, Patent Literature 1 discloses a pedometer that determines walking compatibility through comparison of activity intensities, which are pieces of information that depend on walking pitch, by directly exchanging the activity intensities with another pedometer.

Patent Literature 2 discloses a mobile terminal that does not exchange exercise information but includes a body sensor that measures bodily information of a user, a microphone that collects audio in the surroundings of the user, and a near-field wireless communication unit. The mobile terminal determines the status of the user using the audio or the like, and if it is determined that the status of the user has changed, the mobile terminal records an image or audio at that time. Then, the recorded image or audio can be exchanged with another mobile terminal a short distance away.

As an apparatus that uses audio, Patent Literature 3 discloses a sleep state detection apparatus that determines a sleeping state by performing analysis of a snoring sound or the like based on audio information collected using a microphone, and performs notification via a network in the case where a sleep abnormality is identified.

### CITATION LIST

### Patent Literature

Patent Literature 1: JP 2011-090426A
Patent Literature 2: JP 2005-110869A
Patent Literature 3: JP 2005-304942A

### SUMMARY OF INVENTION

### Technical Problem

According to Patent Literature 1, by using exercise information of multiple users, it is possible to provide a user with a service that has never been provided before. It is also conceivable to provide a service of detecting that multiple exercise information measurement apparatuses are nearby by not only exchanging exercise information, but also using a near-field wireless communication function, whereby additional value is given to the respective users of the multiple exercise information measurement apparatuses. By providing such a service, it is possible to promote use of the exercise information measurement apparatus and to achieve progress in the health of the user.

In order to perform transmission and reception of information between multiple apparatuses and detect that multiple apparatuses are nearby using the near-field wireless communication function in this way, it is necessary to always keep the near-field wireless communication function on, which increases the power consumption of the apparatus. Also, although it is conceivable to switch on the near-field wireless communication function through a manual operation only when the user desires to exchange information or the like, this increases inconvenience to the user.

With the apparatuses disclosed in Patent Literature 1 and 2, the near-field wireless communication function is always on, and therefore power consumption cannot be reduced.

Since the apparatus disclosed in Patent Literature 3 does not have the near-field wireless communication function, no consideration has been given to the problem of reducing the power consumption of an apparatus that uses the near-field wireless communication function.

The present invention has been achieved in view of the foregoing circumstances, and it is an object thereof to provide an exercise information measurement apparatus, a control method therefor, and a control program therefor, according to which it is possible to suppress power consumption and provide a user with additional value obtained by using a near-field wireless communication function.

### Solution to the Problem

An exercise information measurement apparatus according to the present invention includes: a detection unit configured to detect information corresponding to a motion of a user; an exercise information measurement unit configured to measure exercise information of the user based on the information detected by the detection unit; a communication unit for performing near-field wireless communication with another apparatus having a function of measuring exercise information of a user; a sound detection unit configured to detect sound; a determination unit configured to determine whether or not a person is present based on sound detected by the sound detection unit; and a communication operation state control unit configured to control an operation state of the communication unit based on a result of the determination performed by the determination unit.

A control method for an exercise information measurement apparatus according to the present invention is a control method for an exercise information measurement apparatus including a detection unit configured to detect information corresponding to a motion of a user, an exercise information measurement unit configured to measure exercise information of the user based on the information detected by the detection unit, a communication unit for performing near-field wireless communication with another apparatus having a function of measuring exercise information of a user, and a sound detection unit configured to detect sound, the method including: a determination step of determining whether or not a person is present based on the sound detected by the sound detection unit; and a step of controlling an operation state of the communication unit based on a result of the determination performed in the determination step.

A control program for an exercise information measurement apparatus according to the present invention is a program for causing a computer to execute the steps of the control method for an exercise information measurement apparatus.

### Advantageous Effects of Invention

According to the present invention, it is possible to provide an exercise information measurement apparatus, a control method therefor, and a control program therefor, according to which it is possible to suppress power consumption and provide a user with additional value obtained by using a near-field wireless communication function.

### BRIEF DESCRIPTION OF DRAWINGS

FIG. 1 is a block diagram showing a schematic configuration of an exercise information measurement apparatus 10 for illustrating an embodiment of the present invention.

FIG. 2 is a diagram showing functional blocks realized by a control unit 2 of the exercise information measurement apparatus 10 shown in FIG. 1.

FIG. 3 is a flowchart for illustrating operations performed by the exercise information measurement apparatus 10 shown in FIG. 1.

FIG. 4 is a diagram showing a modified example of functional blocks of the control unit 2 of the exercise information measurement apparatus 10 shown in FIG. 1.

FIG. 5 is a flowchart for illustrating operations performed by the exercise information measurement apparatus 10 including the control unit 2 shown in FIG. 4.

### DESCRIPTION OF EMBODIMENTS

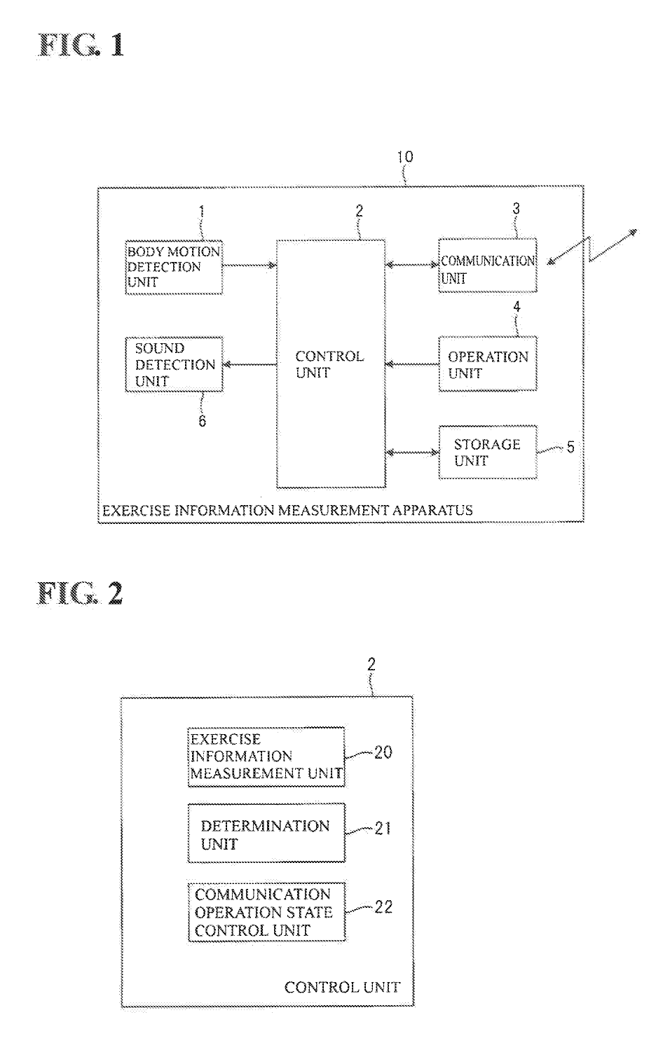

FIG. 1 is a block diagram showing a schematic configuration of an exercise information measurement apparatus 10 for illustrating an embodiment of the present invention. The exercise information measurement apparatus 10 is used while worn on the body of a user (also includes a state of being inserted in a pocket of a piece of clothing), and specifically, it is a pedometer, an activity amount meter, a sports watch, or the like. Also, the exercise information measurement apparatus 10 is not limited to being a dedicated device for measuring exercise information and may be an electronic device having another main function, such as a smartphone.

The exercise information measurement apparatus 10 includes a body motion detection unit 1, a control unit 2 that performs overall control, a communication unit 3, an operation unit 4, a storage unit 5 that includes a storage medium such as a flash memory or a ROM (Read Only Memory), and a sound detection unit 6.

The body motion detection unit 1 detects information (acceleration, angular velocity, and the like) corresponding to motion of a part of the body of a user to which the exercise information measurement apparatus 10 is attached. The body motion detection unit 1 includes various motion sensors such as an acceleration sensor and an angular velocity sensor, and a signal processing unit that processes signals output from the various motion sensors. It is sufficient that the body motion detection unit 1 includes at least one motion sensor and a signal processing unit that processes signals from the motion sensor. The body motion detection unit 1 functions as a detection unit that detects information corresponding to the motion of the user.

The control unit 2 is constituted mainly by a processor that executes a program stored in the ROM of the storage unit 5.

The communication unit 3 is an interface for performing near-field wireless communication with an electronic device including another exercise information measurement apparatus 10. Near-field wireless communication refers to communication that conforms to a communication standard according to which direct communication can be performed between apparatuses without using a network such as the Internet. As the interface, a communication interface that conforms to ANT (a standard for PANs (Personal Area Networks), a communication interface that conforms to Bluetooth (registered trademark), or the like is used.

The operation unit 4 is a device for inputting various instructions to the control unit 2, and is constituted by a button, a touch panel, or the like.

The storage unit 5 stores detection information detected by the body motion detection unit 1, stores information received via the communication unit 3, and stores information needed for the operation of the exercise information measurement apparatus 10.

The sound detection unit 6 detects sound in the surroundings of the exercise information measurement apparatus 10 and is constituted by a microphone, for example.

FIG. 2 is a diagram showing functional blocks realized by the control unit 2 of the exercise information measurement apparatus 10 shown in FIG. 1. The functional blocks are formed due to a processor executing a program stored in the storage unit 5.

As shown in FIG. 2, the control unit 2 includes an exercise information measurement unit 20, a determination unit 21, and a communication operation state control unit 22.

The exercise information measurement unit 20 measures the exercise information of the user based on the detection information detected by the body motion detection unit 1. The exercise information includes the user's activity amount (step count, walking distance, expended calories, or the like), movement speed, and the like. The movement speed is information that indicates the speed of the movement, such as a walking speed or a running speed. It is sufficient that an activity amount including at least the step count is included as the exercise information.

Based on the sound detected by the sound detection unit 6, the determination unit 21 determines the presence of a person (a person other than the user) in the surroundings of the exercise information measurement apparatus 10. Specifically, the determination unit 21 determines that a person is present in the surroundings of the exercise information measurement apparatus 10 if the volume (decibel value) of the sound detected by the sound detection unit 6 exceeds a pre-determined threshold value and the frequency of the sound falls within a pre-determined specific frequency range. For the specific frequency range, a frequency range known as that of a person's voice is set.

The communication operation state control unit 22 controls the operation state of the communication unit 3 based on the result of the determination performed by the determination unit 21. Specifically, if it is determined by the determination unit 21 that a person is present, the communication operation state control unit 22 causes the operation state of the communication unit 3 to transition from an operation state in which the power consumption of the communication unit 3 is at a first value, to an operation state in which the power consumption of the communication unit 3 is at a second value that is greater than the first value. Also, if it is determined by the determination unit 21 that no person is present, the communication operation state control unit 22 causes the operation state of the communication unit 3 to transition from an operation state in which the power consumption of the communication unit 3 is at the second value, to an operation state in which the power consumption of the communication unit 3 is at the first value.

For example, the operation state in which the power consumption of the communication unit 3 is at the first value is a state in which the communication unit 3 is stopped (powered off). The operation state in which the power consumption of the communication unit 3 is at the second value is a state in which the communication unit 3 is operating (powered on).

Alternatively, the operation state in which the power consumption of the communication unit 3 is at the first value is a state in which the communication unit 3 is powered on but the intervals between instances of carrying out communication processing needed to establish communication with another apparatus are made longer so as to reduce power consumption, for example. The operation state in which the power consumption of the communication unit 3 is at the second value is a state in which the intervals between instances of carrying out the communication processing are made shorter.

Operations performed by the exercise information measurement apparatus 10 configured as described above will be described.

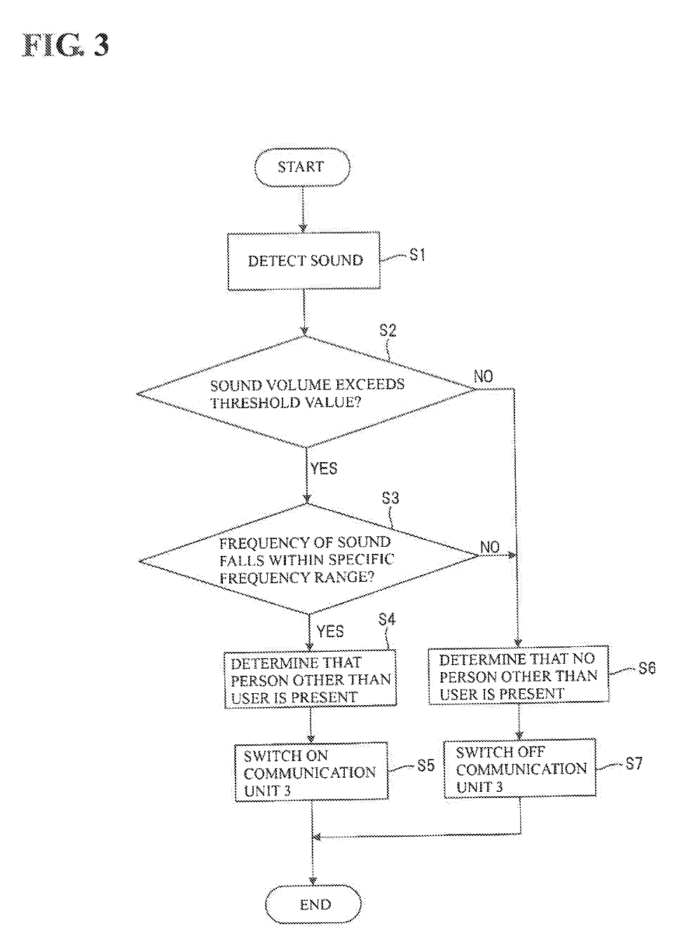

FIG. 3 is a flowchart for illustrating operations performed by the exercise information measurement apparatus 10 shown in FIG. 1.

When the power of the exercise information measurement apparatus 10 is switched on, detection of sound in the surroundings is performed by the sound detection unit 6 (step S1). When sound is detected, the control unit 2 determines whether or not the volume of the detected sound exceeds the threshold value (step S2).

If the volume of the detected sound does not exceed the threshold value (step S2: NO), the control unit 2 determines that no person other than the user is present in the surroundings of the exercise information measurement apparatus 10 (step S6), switches off the power of the communication unit 3 (step S7), and thus reduces the power consumption.

If the volume of the detected sound has exceeded the threshold value (step S2: YES), the control unit 2 determines whether or not the frequency of the detected sound falls within the specific frequency range (step S3).

If the frequency of the detected sound is outside of the specific frequency range (step S3: NO), the control unit 2 determines that no person other than the user is present in the surroundings of the exercise information measurement apparatus 10 (step S6) and switches off the power of the communication unit 3 (step S7), thereby reducing the power consumption.

If the frequency of the detected sound falls within the specific frequency range (step S3: YES), the control unit 2 determines that a person other than the user is present in the surroundings of the exercise information measurement apparatus 10 (step S4) and switches on the power of the communication unit 3 (step S5), thereby causing a transition to a state in which communication with another exercise information measurement apparatus 10 is possible.

The above-described processing is performed continuously while the exercise information measurement apparatus 10 operates. The state in which it is determined that no person other than the user is present in the surroundings of the exercise information measurement apparatus 10 can be said to be a state in which no other exercise information measurement apparatus 10 that can communicate with the exercise information measurement apparatus 10 is present nearby. For this reason, when in this kind of state, the power consumption of the exercise information measurement apparatus 10 can be reduced by switching off the power of the communication unit 3 (switching to a state in which the power consumption is at the first value). Also, since the power of the communication unit 3 is switched on and off automatically even if the user of the exercise information measurement apparatus 10 does not perform a special operation, lower power consumption can be realized without burdening the user.

The determination unit 21 may determine that a person is present in the surroundings of the exercise information measurement apparatus 10 if the volume of the sound detected by the sound detection unit 6 exceeds the threshold value, regardless of the frequency of the sound. In other words, a configuration is possible in which the processing of step S3 is omitted in the flowchart of FIG. 3 and the processing of step S4 is performed when the result of the determination in step S2 is YES.

If the volume of the detected sound exceeds the threshold value, there is a high likelihood that the user wearing the exercise information measurement apparatus 10 is at a location where many people are present, such as a busy street or inside of a moving train. For this reason, the power consumption can be reduced by performing the processing of steps S4 and S5 only when in this kind of state.

The determination unit 21 may determine that a person is present in the surroundings of the exercise information measurement apparatus 10 if the frequency of the sound detected by the sound detection unit 6 is within the specific frequency range, regardless of the volume of the sound. In other words, a configuration is possible in which the processing of step S2 is omitted in the flowchart of FIG. 3 and the processing of step S3 is performed after the processing of step S1.

Since it is rare that a user talks to himself or herself, there is a high likelihood that a person other than the user is present in the surroundings of the exercise information measurement apparatus 10 in the case where the frequency of the detected sound falls within the specific frequency range. For this reason, the power consumption can be reduced by performing the processing of steps S4 and S5 only when this kind of state is determined.

Note that as shown in FIG. 3, by determining that a person other than the user is present when the result of the determination in step S2 is YES and the result of the determination in step S3 is YES, it is possible to determine the presence of a person other than the user with high accuracy, and the power consumption can be more effectively reduced in comparison to an operation in which only one of steps S2 and S3 is performed.

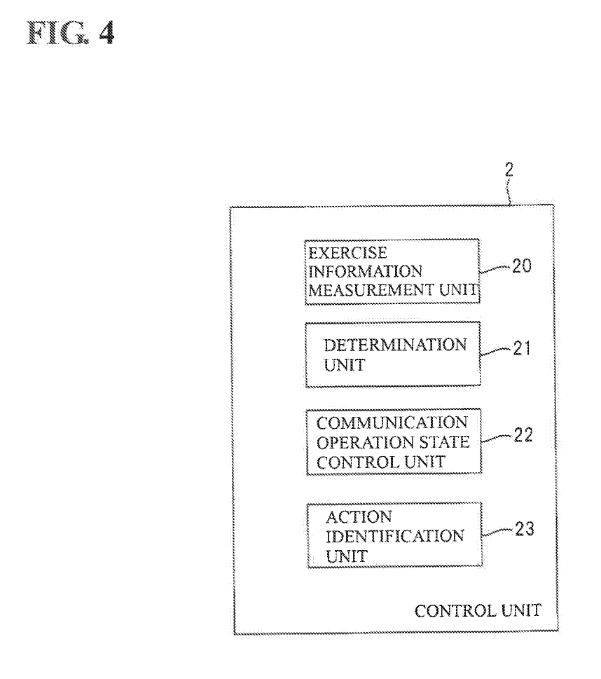

FIG. 4 is a diagram showing a modified example of the functional blocks of the control unit 2 shown in FIG. 2. The control unit 2 shown in FIG. 4 has the same configuration as that shown in FIG. 2, except that an action identification unit 23 has been added.

Based on information corresponding to a motion of the user detected by the body motion detection unit 1, the action identification unit 23 performs processing for identifying a pre-determined action type, such as walking, running, standing, sitting, lying down, riding a moving body such as a train or a bus, being at home, or being away from home. The action identification unit 23 can also perform action identification using information from a sensor other than the body motion detection unit 1, such as a GPS (Global Positioning System) receiver provided in the exercise information measurement apparatus 10.

For example, if the GPS receiver is mounted in the exercise information measurement apparatus 10, it is possible to identify whether or not the user is away from home by viewing a degree of matching between pre-registered positional information of the user's home and positional information acquired by the GPS receiver. Alternatively, the action identification unit 23 may identify that the user is away from home in the case where it is determined that the user is continuously performing walking or running based on the information from the body motion detection unit 1.

The determination unit 21 of the control unit 2 shown in FIG. 4 determines the presence of a person in the surroundings of the exercise information measurement apparatus 10 based on the sound detected by the sound detection unit 6 and the result of the action identification performed by the action identification unit 23. For example, the determination unit 21 determines that a person is present in the surroundings of the exercise information measurement apparatus 10 if the result of the action identification performed by the action identification unit 23 is “away from home”, the volume of the sound detected by the sound detection unit 6 exceeds a threshold value, and the frequency of the sound falls within a specific frequency region.

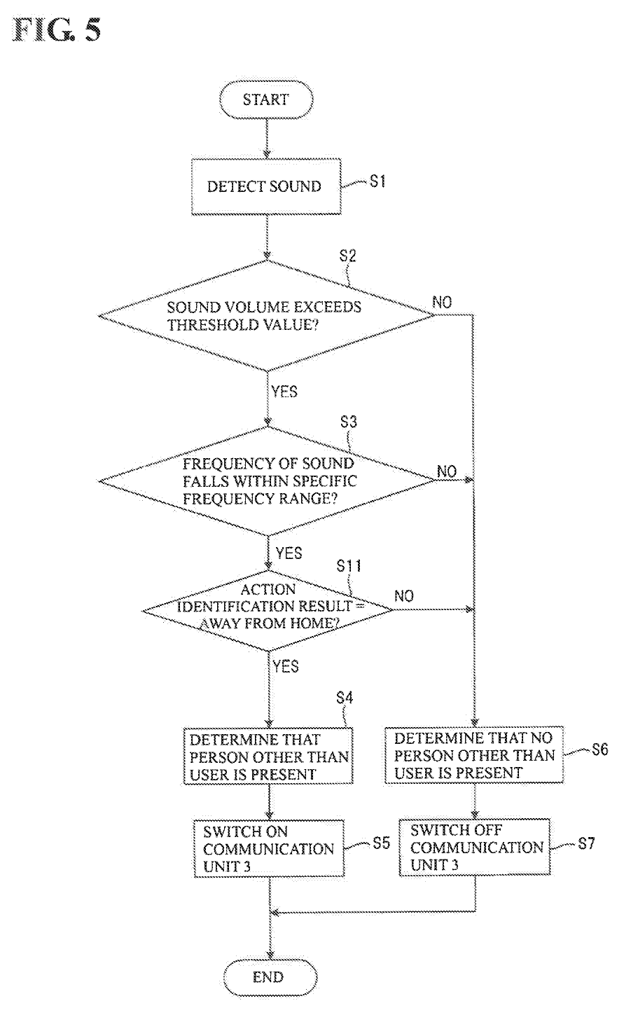

FIG. 5 is a flowchart for illustrating operations performed by the exercise information measurement apparatus 10 including the control unit 2 shown in FIG. 4. In FIG. 5, processes that are the same as in FIG. 3 are denoted by the same reference numerals thereas, and description thereof is not included here.

When the result of the determination in step S3 is YES, the control unit 2 performs action identification processing and identifies the current action of the user. Also, if the action of the user is not “away from home”, or in other words, if the user is at home (step S11: NO), the control unit 2 performs the processing of step S6 and onward. Even if the result of the determination in steps S2 and S3 is YES, if the result of the determination in step S11 is NO, it is envisioned that the user is performing an action such as viewing television at home. For this reason, it can be determined that no partner requiring communication is in the surroundings. Accordingly, in such a case, it is possible to eliminate wasteful power consumption by switching off the power of the communication unit 3.

If the result of the determination in step S11 is YES, the control unit 2 performs the processing of step S4 and onward. It is possible to determine that a person is present with high probability in the surroundings of the user if the result of the determination in steps S2 and S3 is YES and the result of the determination in step S11 is YES. For this reason, it is possible to eliminate wasteful power consumption by switching on the power of the communication unit 3 only in such a case.

As described above, by determining the presence of a person other than the user in the surroundings of the action information measurement apparatus 10 using the result of the action identification as well as the sound detected by the sound detection unit 6, more accurate determination can be performed, and the power consumption can be reduced more effectively. When away from home, there is a high likelihood of passing by various people, and therefore the power of the communication unit 3 is switched on only when it is determined that the user is away from home, whereby it is possible to eliminate wasteful power consumption while at home.

Step S2 or S3 may be omitted in the flowchart shown in FIG. 5, similarly to the flowchart in FIG. 3.

In the operation example shown in FIG. 5, the processing of step S4 and onward is performed when the action identification result in the determination of step S11 is that the user is away from home. As a modified example of this, it is possible to use a configuration in which the processing of step S4 and onward is performed if the action identification result is that the user is walking, running, or riding in a moving body, for example. If the user is moving, there is a high likelihood that the user will pass by many people. For this reason, it is effective to perform the processing of step S4 and onward only in such a case.

In the description above, the sound detection unit 6 always operates. However, it is possible to use a configuration in which the sound detection unit 6 operates only in the case where it is envisioned that there is a high likelihood that a person will be present in the surroundings, such as a case where the control unit 2 performs the action identification processing and the result of the action identification processing is that the user is away from home, walking, running, or riding in a moving body. In this case, the processing of step S1 and onward in FIG. 3 is performed after the sound detection unit 6 operates. With this configuration, the sound detection unit 6 need not always operate, and therefore it is possible to further reduce the power consumption.

A program for causing a computer to execute the processing of the functional blocks shown in FIGS. 2 and 4 can be provided by recording the program in a computer-readable non-transitory recording medium.

Examples of this kind of “computer-readable recording medium” include an optical medium such as a CD-ROM (Compact Disc-ROM), a magnetic recording medium such as a memory card, and the like. Also, this kind of program can be provided by downloading via a network.

The embodiment disclosed herein is to be thought of as being in all ways exemplary and in no ways limiting. The scope of the present invention is indicated by the claims and not by the above-described embodiment, and equivalent meanings as well as all modifications that fall within the scope are intended to be included in the scope of the invention.

As described above, the following items are disclosed in the present specification.

The disclosed exercise information measurement apparatus includes: a detection unit configured to detect information corresponding to a motion of a user, an exercise information measurement unit configured to measure exercise information of the user based on the information detected by the detection unit; a communication unit for performing near-field wireless communication with another apparatus having a function of measuring exercise information of a user, a sound detection unit configured to detect sound; a determination unit configured to determine whether or not a person is present based on sound detected by the sound detection unit; and a communication operation state control unit configured to control an operation state of the communication unit based on a result of the determination performed by the determination unit.

With the disclosed exercise information measurement apparatus, the determination unit determines that a person is present if the volume of the sound detected by the sound detection unit exceeds a threshold value, or if the frequency of the sound falls within a specific frequency range.

With the disclosed exercise information measurement apparatus, the determination unit determines that a person is present if the volume of the sound detected by the sound detection unit exceeds a threshold value and the frequency of the sound falls within a specific frequency range.

The disclosed exercise information measurement apparatus further includes an action identification unit configured to identify an action of the user, wherein the determination unit determines that a person is present based on the sound detected by the sound detection unit and a result of the action identification performed by the action identification unit.

With the disclosed exercise information measurement apparatus, the determination unit determines that a person is present if the result of the action identification indicates that the user is away from home, and if the volume of the sound detected by the sound detection unit exceeds a threshold value or the frequency of the sound falls within a specific frequency range.

With the disclosed exercise information measurement apparatus, the determination unit determines that a person is present if the result of the action identification indicates that the user is away from home, and if the volume of the sound detected by the sound detection unit exceeds a threshold value and the frequency of the sound falls within a specific frequency range.

With the disclosed exercise information measurement apparatus, if it is determined by the determination unit that a person is present, the communication operation state control unit causes a transition from an operation state in which power consumption of the communication unit is at a first value, to an operation state in which power consumption of the communication unit is at a second value that is larger than the first value.

The disclosed control method for an exercise information measurement apparatus is a control method for an exercise information measurement apparatus including a detection unit configured to detect information corresponding to a motion of a user, an exercise information measurement unit configured to measure exercise information of the user based on the information detected by the detection unit, a communication unit for performing near-field wireless communication with another apparatus having a function of measuring exercise information of a user, and a sound detection unit configured to detect sound, the method including: a determination step of determining whether or not a person is present based on the sound detected by the sound detection unit; and a step of controlling an operation state of the communication unit based on a result of the determination performed in the determination step.

The disclosed control program for an exercise information measurement apparatus is a program for causing a computer to execute the steps of the control method for an exercise information measurement apparatus.

### INDUSTRIAL APPLICABILITY

According to the present invention, it is possible to provide an exercise information measurement apparatus, a control method therefor, and a control program therefor, according to which it is possible to suppress power consumption and provide a user with additional value obtained by using a near-field wireless communication function.

While the present invention has been described with reference to specific embodiments, the present invention is not limited to these embodiments, and many variations and modifications can be made without departing from the technical idea of the disclosed invention.

The present application claims the benefit of Japanese Patent Application 2015-10343 filed on Jan. 22, 2015, which is hereby incorporated herein in its entirety.

### REFERENCE SIGNS LIST

10 Exercise information measurement apparatus
1 Body motion detection unit
2 Control unit
3 Communication unit
4 Operation unit
Storage unit
6 Sound detection unit
20 Exercise information measurement unit
21 Determination unit
22 Communication operation state control unit
23 Action identification unit

1. An exercise information measurement apparatus, comprising:
a detection unit configured to detect information corresponding to a motion of a user;
an exercise information measurement unit configured to measure exercise information of the user based on the information detected by the detection unit;
a communication unit for performing near-field wireless communication with another apparatus having a function of measuring exercise information of a user;
a sound detection unit configured to detect sound;
a determination unit configured to determine whether or not a person is present based on sound detected by the sound detection unit; and
a communication operation state control unit configured to control an operation state of the communication unit based on a result of the determination performed by the determination unit.

2. The exercise information measurement apparatus according to claim 1, wherein
the determination unit determines that a person is present if the volume of the sound detected by the sound detection unit exceeds a threshold value, or if the frequency of the sound falls within a specific frequency range.

3. The exercise information measurement apparatus according to claim 1, wherein
the determination unit determines that a person is present if the volume of the sound detected by the sound detection unit exceeds a threshold value and the frequency of the sound falls within a specific frequency range.

4. The exercise information measurement apparatus according to claim 1, further comprising
an action identification unit configured to identify an action of the user,
wherein the determination unit determines that a person is present based on the sound detected by the sound detection unit and a result of the action identification performed by the action identification unit.

5. The exercise information measurement apparatus according to claim 4,
wherein the determination unit determines that a person is present if the result of the action identification indicates that the user is away from home, and if the volume of the sound detected by the sound detection unit exceeds a threshold value or the frequency of the sound falls within a specific frequency range.

6. The exercise information measurement apparatus according to claim 4,
wherein the determination unit determines that a person is present if the result of the action identification indicates that the user is away from home, and if the volume of the sound detected by the sound detection unit exceeds a threshold value and the frequency of the sound falls within a specific frequency range.

7. The exercise information measurement apparatus according to claim 1, wherein
if it is determined by the determination unit that a person is present, the communication operation state control unit causes a transition from an operation state in which power consumption of the communication unit is at a first value, to an operation state in which power consumption of the communication unit is at a second value that is larger than the first value.

8. A control method for an exercise information measurement apparatus including a detection unit configured to detect information corresponding to a motion of a user, an exercise information measurement unit configured to measure exercise information of the user based on the information detected by the detection unit, a communication unit for performing near-field wireless communication with another apparatus having a function of measuring exercise information of a user, and a sound detection unit configured to detect sound, the method comprising:
a determination step of determining whether or not a person is present based on the sound detected by the sound detection unit; and
a step of controlling an operation state of the communication unit based on a result of the determination performed in the determination step.

9. A control program for causing a computer to execute the steps of the control method for an exercise information measurement apparatus according to claim 8.

10. The exercise information measurement apparatus according to claim 2, wherein
if it is determined by the determination unit that a person is present, the communication operation state control unit causes a transition from an operation state in which power consumption of the communication unit is at a first value, to an operation state in which power consumption of the communication unit is at a second value that is larger than the first value.

11. The exercise information measurement apparatus according to claim 3, wherein
if it is determined by the determination unit that a person is present, the communication operation state control unit causes a transition from an operation state in which power consumption of the communication unit is at a first value, to an operation state in which power consumption of the communication unit is at a second value that is larger than the first value.

12. The exercise information measurement apparatus according to claim 4, wherein
if it is determined by the determination unit that a person is present, the communication operation state control unit causes a transition from an operation state in which power consumption of the communication unit is at a first value, to an operation state in which power consumption of the communication unit is at a second value that is larger than the first value.

13. The exercise information measurement apparatus according to claim 5, wherein
if it is determined by the determination unit that a person is present, the communication operation state control unit causes a transition from an operation state in which power consumption of the communication unit is at a first value, to an operation state in which power consumption of the communication unit is at a second value that is larger than the first value.

14. The exercise information measurement apparatus according to claim 6, wherein
if it is determined by the determination unit that a person is present, the communication operation state control unit causes a transition from an operation state in which power consumption of the communication unit is at a first value, to an operation state in which power consumption of the communication unit is at a second value that is larger than the first value.
